(19) United States
(12) Patent Application Publication
(10) Pub. No.: US 2026/0181171 A1
(43) Pub. Date: Jun. 25, 2026

(54) MESH DECODING DEVICE, MESH DECODING METHOD, AND PROGRAM

(71) Applicant: KDDI CORPORATION, Tokyo (JP)

(72) Inventors: Emi MYOUDOU, Fujimino-shi (JP); Jiangfen XU, Fujimino-shi (JP); Koki KISHIMOTO, Fujimino-shi (JP); Kei KAWAMURA, Fujimino-shi (JP)

(73) Assignee: KDDI CORPORATION, Tokyo (JP)

(21) Appl. No.: 19/422,176

(22) Filed: Dec. 16, 2025

Related U.S. Application Data
(63) Continuation of application No. PCT/JP2024/007921, filed on Mar. 3, 2024.

(30) Foreign Application Priority Data
Jul. 7, 2023 (JP) 2023-112558

(51) Int. Cl. H04N 19/44; G06T 9/00; H04N 19/13; H04N 19/172; H04N 19/176; H04N 19/70

(52) U.S. Cl. CPC H04N 19/44; G06T 9/001; H04N 19/13; H04N 19/172; H04N 19/176; H04N 19/70

(57) ABSTRACT

A mesh decoding device 200 according to the present invention includes: an atlas data decoding unit 207 configured to decode a syntax defining a maximum value of the number of iterations of subdivision, wherein the syntax decoded by the atlas data decoding unit 207 has a value of 15 or less.

### CROSS-REFERENCE TO RELATED APPLICATIONS

The present application is a continuation of PCT Application No. PCT/JP2024/007921, filed on Mar. 3, 2024, which claims the benefit of Japanese patent application No. 2023-112558 filed on Jul. 7, 2023, the entire contents of each application being incorporated herein by reference in its entirety.

### TECHNICAL FIELD

The present invention relates to a mesh decoding device, a mesh decoding method, and a program.

### BACKGROUND ART

Non Patent Literature 1 (Khaled Mammou, Jungsun Kim, Alexis Tourapis, Dimitri Podborski, Krasimir Kolarov, “[V-CG] Apple's Dynamic Mesh Coding CfP Response,” ISO/IEC JTC 1/SC 29/WG 7 m5928, April 2022) discloses a technology for dividing a mesh into a rough base mesh and a detailed displacement, and encoding and decoding the divided mesh.

Specifically, in such a technology, when decoded, a bit stream is demultiplexed into a base mesh bit stream and a displacement bit stream. After being decoded by a base mesh decoding unit, the base mesh bit stream is repeatedly subdivided by a subdivision unit to decode a fine mesh. Thereafter, the displacement is added and subtracted, and a decoded mesh is output.

In Non Patent Literature 2 (“WD 3.0 of V-DMC,” ISO/IEC JTC 1/SC 29/WG7 w22775, April 2023), a design for realizing the technology disclosed in Non Patent Literature 1 is made.

### SUMMARY OF THE INVENTION

However, Non Patent Literature 2 has a problem that an unreasonable number of iterations of subdivision is set, which makes the design difficult. Therefore, the present invention has been made in view of the above-described problems, and an object thereof is to provide a mesh decoding device, a mesh decoding method, and a program that can be implemented by a simple design.

A first feature of the present invention is summarized as a mesh decoding device including: an atlas data decoding unit configured to decode a syntax defining a maximum value of the number of iterations of subdivision, wherein the syntax decoded by the atlas data decoding unit has a value of 15 or less.

A second feature of the present invention is summarized as a mesh decoding device including: an atlas data decoding unit configured to decode a syntax defining a maximum value of the number of iterations of subdivision, wherein the syntax decoded by the atlas data decoding unit has a value of 7 or less.

A third feature of the present invention is summarized as a mesh decoding device including: an atlas data decoding unit configured to decode a syntax defining a maximum value of the number of iterations of subdivision, wherein when high quality is set, the syntax decoded by the atlas data decoding unit has a value of 7 or less, and when general quality is set, the syntax decoded by the atlas data decoding unit has a value of 15 or less.

A fourth feature of the present invention is summarized as a mesh decoding method including: a step of decoding a syntax defining a maximum value of the number of iterations of subdivision, wherein the syntax decoded in the step has a value of 15 or less.

A fifth feature of the present invention is summarized as a non-transitory computer-readable medium having stored thereon a program that is executable by a computer to cause the computer to function as a mesh decoding device, wherein the mesh decoding device includes an atlas data decoding unit configured to decode a syntax defining a maximum value of the number of iterations of subdivision, and the syntax decoded by the atlas data decoding unit has a value of 15 or less.

According to the present invention, it is possible to provide a mesh decoding device, a mesh decoding method, and a program that can be implemented by a simple design.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3 is a flowchart illustrating an example of an operation of a subdivision unit 203.

FIG. 4 is an example of a parameter set and a data unit related to subdivision.

FIG. 5 is a diagram illustrating an example of an ASPS syntax configuration.

FIG. 6 is a diagram illustrating an example of an AFPS syntax configuration.

FIG. 7 is a diagram illustrating an example of a PDU syntax configuration.

FIG. 8A is a diagram illustrating a base mesh input to the subdivision unit 203.

FIG. 8B is a diagram illustrating a subdivision mesh after one time of subdivision.

FIG. 9A is a diagram illustrating an example of a tetrahedron to be subdivided.

FIG. 9B is a table summarizing the number of iterations of subdivision, the number of bits required, the number of faces, and the number of vertices when the tetrahedron illustrated in FIG. 9A is subdivided.

### DESCRIPTION OF EMBODIMENTS

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

### First Embodiment

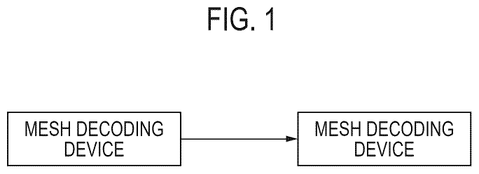

Hereinafter, a mesh processing system 1 according to the present embodiment will be described with reference to FIGS. 1 to 9.

FIG. 1 is a diagram illustrating an example of a configuration of the mesh processing system 1 according to the present embodiment. As illustrated in FIG. 1, the mesh processing system 1 includes a mesh encoding device 100 and a mesh decoding device 200.

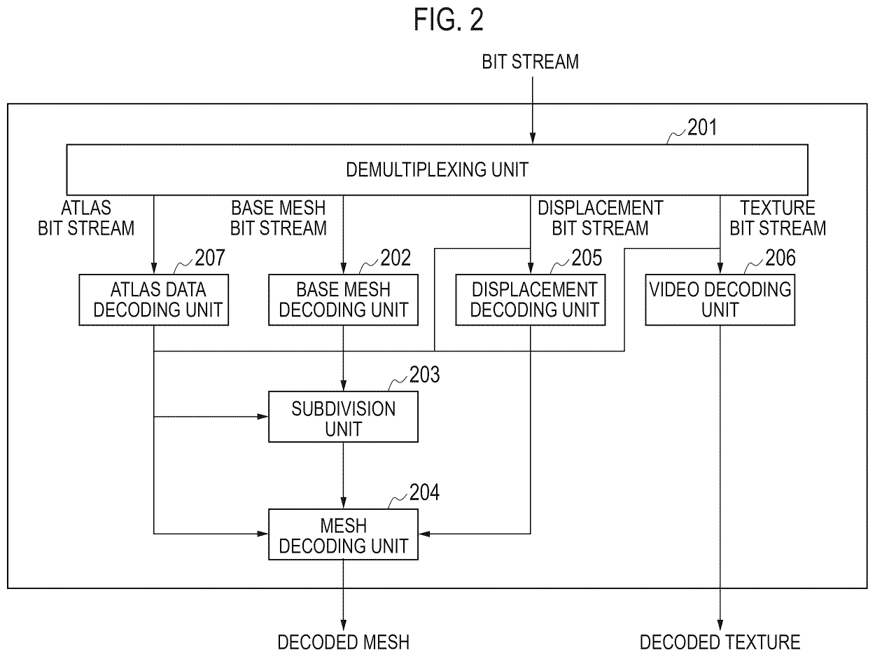

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a displacement amount decoding unit 205, a video decoding unit 206, and an atlas data decoding unit 207.

The demultiplexing unit 201 is configured to separate a multiplexed bit stream into an atlas bit stream, a sub-mesh bit stream, a displacement bit stream, a texture bit stream, and an atlas bit stream.

The base mesh decoding unit 202 is configured to decode a base mesh bit stream, and generate and output a base mesh.

The subdivision unit 203 is configured to decode the control information output from the atlas data decoding unit 207, the control information output from the base mesh decoding unit 202, and the base mesh to output the subdivision mesh and the subdivision vertex normal.

Here, the base sub-mesh, the added subdivision vertex, and the connection information thereof are collectively referred to as a “subdivision mesh”.

The mesh decoding unit 204 is configured to generate and output a decoded mesh using the subdivision mesh generated by the subdivision unit 203 and the displacement amount decoded by the displacement amount decoding unit 205.

The displacement decoding unit 205 is configured to decode a displacement bit stream to generate and output a displacement.

The video decoding unit 206 is configured to decode and output texture by video codec. For example, the video decoding unit 206 may use HEVC described in Non Patent Literature 1.

The atlas data decoding unit 207 is configured to decode an atlas bit stream and output control information.

### (Subdivision Unit 203)

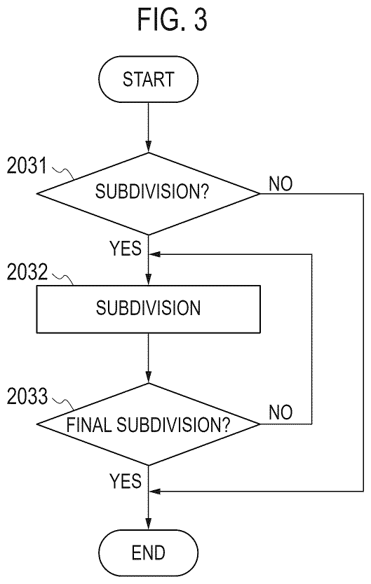

FIG. 3 is a flowchart illustrating an example of an operation of the subdivision unit 203.

As illustrated in steps S2031 to S2033 of FIG. 3, the subdivision unit 203 repeats subdivision by a predetermined number of iterations of subdivision.

### (Configuration of Displacement Bit Stream)

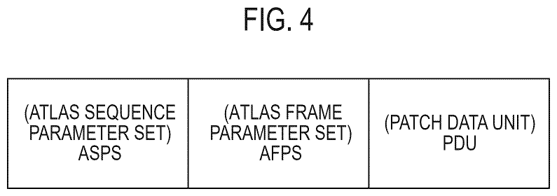

Hereinafter, an example of a configuration of a bit stream related to subdivision will be described with reference to FIGS. 4 to 7.

FIG. 4 is an example of a parameter set and a data unit to which an atlas relates, including information for control of subdivision. This is control information obtained by the atlas data decoding unit 207 in Non Patent Literature 2, but it may be moved to another bit stream and decoded there as long as the meaning remains the same.

As illustrated in FIG. 4, firstly, the atlas bit stream may include an atlas sequence parameter set (ASPS), which is a set of control information related to decoding of a sequence of atlas information.

Secondly, the atlas bit stream may include an atlas frame parameter set (AFPS), which is a set of control information corresponding to a frame after the ASPS.

Thirdly, the atlas bit stream may include a patch data unit (PDU), which is a patch-based data unit, after the AFPS.

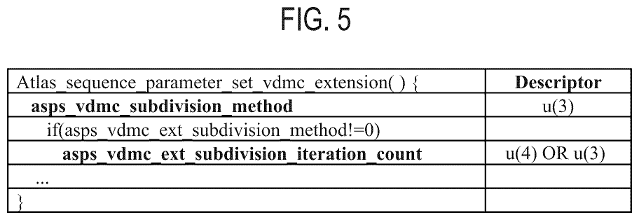

FIGS. 5 to 7 are diagrams each illustrating an example of a syntax. Note that, in FIGS. 5 to 7, the “Descriptor” field represents how each syntax is encoded. In FIGS. 5 to 7, u(n) means an n-bit code.

FIG. 5 is a diagram illustrating an example of an ASPS syntax configuration.

In FIG. 5, the ASPS includes a subdivision method (afps_vdmc_ext_subdivision_method).

For example, it is defined that, when afps_vdmc_ext_subdivision_method is other than 0, subdivision is performed, and the ASPS includes the number of iterations of subdivision (afps_vdmc_ext_subdivision_iteration_count). This is given as u(8) in Non Patent Literature 2.

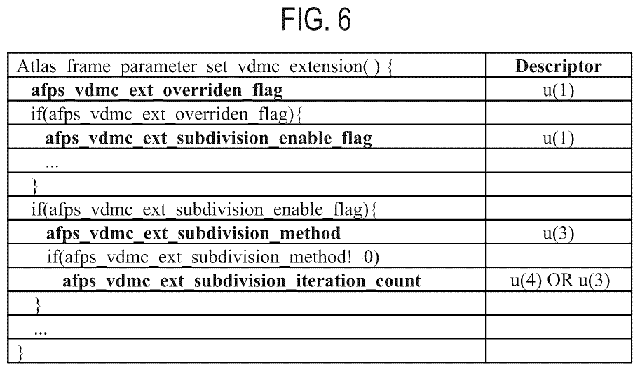

FIG. 6 is a diagram illustrating an example of an AFPS syntax configuration.

The AFPS includes a flag (afps_vdmc_ext_overriden_flag) indicating whether to overwrite.

For example, when afps_vdmc_ext_overriden_flag is 1, the AFPS includes a flag indicating whether to enable subdivision (afps_vdmc_ext_subdivision_enable_flag).

For example, when afps_vdmc_ext_subdivision_enable_flag is 1, subdivision is enabled.

When subdivision is enabled, the AFPS includes a method indicating the subdivision (afps_vdmc_ext_subdivision_method).

For example, when afps_vdmc_ext_subdivision_method is other than 0 and a certain subdivision method is specified, the AFPS includes the number of iterations of subdivision (afps_vdmc_ext_subdivision_iteration_count). This is given as u(8) in Non Patent Literature 2.

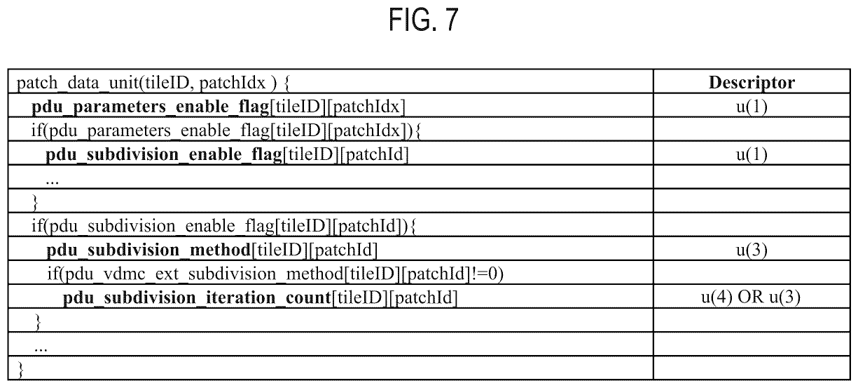

FIG. 7 is a diagram illustrating an example of a PDU syntax configuration. The PDU is data for each patch index.

The PDU includes a flag (pdu_parameters_enable_flag) indicating whether to enable PDU parameters.

For example, when pdu_parameters_enable_flag is 1, the PDU includes a flag indicating whether to enable subdivision (pdu_subdivision_enable_flag).

For example, when pdu_subdivision_enable_flag is 1, subdivision is enabled.

When subdivision is enabled, the PDU includes a method indicating the subdivision (pdu_subdivision_method).

For example, when pdu_subdivision_method is other than 0 and a certain subdivision method is specified, the PDU includes the number of iterations of subdivision (pdu_subdivision_iteration_count). This is given as u(8) in Non Patent Literature 2.

### (Subdivision Unit 203)

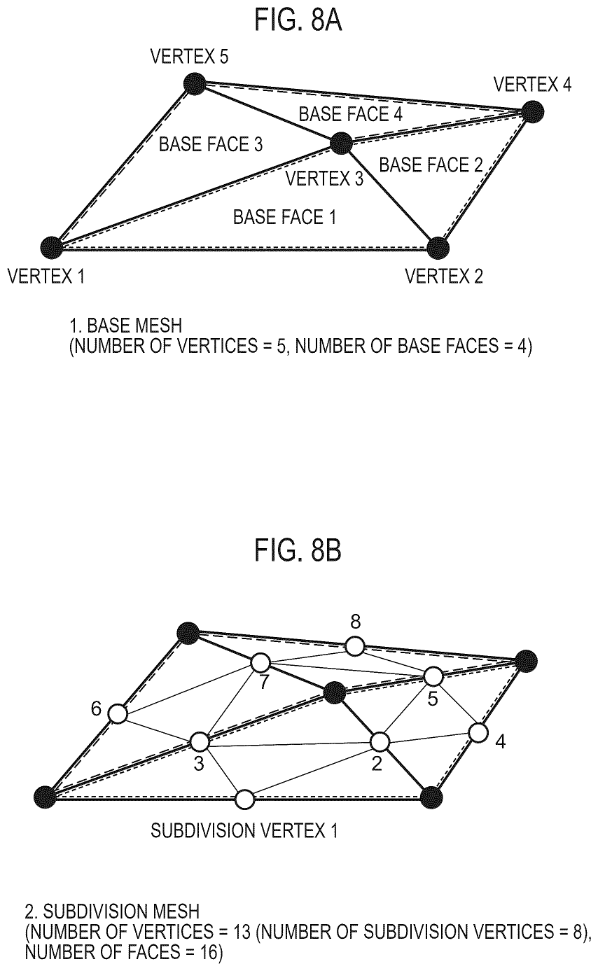

FIGS. 8A and 8B illustrate how the number of vertices and the number of faces change in one time of subdivision.

FIG. 8A illustrates a base mesh input to the subdivision unit 203, and FIG. 8B illustrates a subdivision mesh after one time of subdivision.

In general, when a subdivision method such as midpoint is used for a triangular mesh, the number of subdivision meshes increases by about four times after one time of subdivision.

It can also be seen in FIG. 8B that the number of faces increases by four times the basic number of faces as compared to FIG. 8A. That is, every time subdivision is performed, the number of faces becomes the number of faces before division×4.

In addition, every time subdivision is performed, the number of edges becomes the number of edges before division×2+ the number of faces×3. This is because each edge before division is divided into two, and three new edges are created in one face.

In addition, every time subdivision is performed, the number of vertices becomes the number of edges before division+the number of vertices before division. This is because one new vertex can be formed at the midpoint of each edge before division, and the number of vertices obtained by adding the number of vertices before division becomes the new number of vertices. The number of faces is about twice the number of vertices.

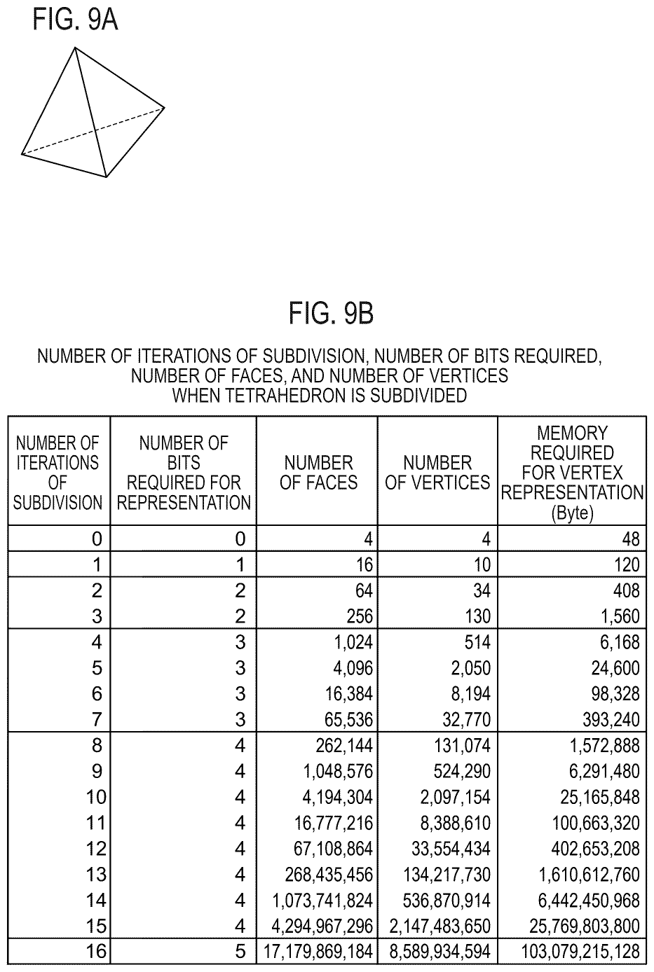

Here, an extremely small base mesh (e.g., a tetrahedron having only four faces) as illustrated as shown in FIG. 9A is assumed.

FIG. 9B shows a table summarizing the number of iterations of subdivision, the number of bits required, the number of faces, the number of vertices, and the memory required for vertex representation when the tetrahedron shown in FIG. 9A is subdivided.

As illustrated in FIG. 9B, in general division up to three times, the number of iterations of subdivision can be represented by 2 bits, the number of faces is 256, and the number of vertices is 130.

If the number of iterations of subdivision is set to 7, which is the upper limit in which the number of iterations of subdivision can be represented by 3 bits, the number of faces is 65,536, and the number of vertices is 32,770.

If the number of iterations of subdivision is set to 15, which is the upper limit in which the number of iterations of subdivision can be represented by 4 bits, the number of faces is 4,294,967,296 (about 4.3 giga), and the number of vertices is 2,147,483,650 (about 2.2 giga) (rounded to one decimal place).

If the number of iterations of subdivision is 16, which is 1 larger than 15 and requires 5 bits for representation, the number of faces is 17,179,869,184 (about 17.2 giga) and the number of vertices is 8,589,934,594 (about 8.6 giga) (rounded to one decimal place).

Here, the memory required for one frame of mesh representation when mesh data compressed under the conditions of FIG. 9B is decoded is roughly calculated for a specific number of iterations of subdivision.

In practice, memory related to the data loaded into memory and the decoding process is also required, but the memory required for decoding and holding one frame is roughly calculated because it is assumed to be large.

### <16 Times>

If the number of iterations of subdivision is set to 16, which is the minimum number of iterations in a case where the number of iterations of subdivision is represented by 5 bits, the number of vertices is about 8.6 giga.

The xyz coordinates of the vertices are often represented by 32-bit floating-point numbers. That is, 12 bytes are required for one vertex. Just for vertex representation, 103.1 GB is required per frame.

In addition, in the mesh representation, connectivity information that connects the vertices is also required, and in order to represent the connectivity information, it is necessary to output a vertex index at least once at each vertex.

In a case where the number of vertices is 8.6 giga, representation of each vertex index requires 33 bits, which is about 4 bytes.

One frame requires 8.6×4=34.4 GB to represent the connectivity information. Therefore, at least 103.1+34.4=137.5 GB is required per frame for mesh representation not including texture or the like.

A maximum of 128 GB of memory is common even in a current high-end desktop personal computer, and 16 iterations of subdivision is not realistic.

In this manner, the mesh representation requires handling various types of information for faces and vertices, which results in a huge amount of memory being required, making implementation extremely difficult from the viewpoint of memory.

### <15 Times>

If the number of iterations of subdivision is set to 15, which is the maximum number of iterations in a case where the number of iterations of subdivision is represented by 4 bits, the number of vertices is about 2.2 giga.

The xyz coordinates of the vertices are often represented by 32-bit floating-point numbers. That is, 12 bytes are required for one vertex. Just for vertex representation, 25.8 GB is required per frame.

In addition, in the mesh representation, connectivity information that connects the vertices is also required, and in order to represent the connectivity information, it is necessary to output a vertex index at least once at each vertex.

In a case where the number of vertices is 2.2 giga, representation of each vertex index requires 31 bits, which is about 4 bytes.

One frame requires 2.2×4=8.8 GB to represent the connectivity information. Therefore, at least 25.8+8.8=34.6 GB is required per frame for mesh representation not including texture or the like.

However, this representation is possible with 64 GB to 128 GB of memory. It is important to set the number of iterations of subdivision within a reasonable range, and it is desirable that the number of iterations of subdivision is 15 or less.

However, a terminal with 64 GB or more of memory is considered as a high-end terminal, and there is a problem in making it widely available. In addition, when a texture, a buffer, a free shape, and the like are considered, 15 subdivisions may be difficult.

### <8 Times>

If the number of iterations of subdivision is set to 8, which is the minimum number of iterations in a case where the number of iterations of subdivision is represented by 4 bits, the number of vertices is 131,074.

The xyz coordinates of the vertices are often represented by 32-bit floating-point numbers. That is, 12 bytes are required for one vertex. Just for vertex representation, 1,572,888 B is required per frame.

In addition, in the mesh representation, connectivity information that connects the vertices is also required, and in order to represent the connectivity information, it is necessary to output a vertex index at least once at each vertex.

In a case where the number of vertices is 131,074, representation of each vertex index requires 18 bits, which is about 2 bytes.

One frame requires 131,074× 2=262,148 B to represent the connectivity information. Therefore, at least 1,572,888+262,148=1,835,036≈1.8 MB is required per frame for mesh representation not including texture or the like.

As described above, in a case where the shape is not complex and no texture information is contained, it can generally be represented with as little as about 1 GB of memory.

However, it is assumed that the shape of the base mesh without subdivision is somewhat complex, and the number of vertices is 514 instead of 4.

This value is also seen for the number of vertices per frame before subdivision used in the MPEG test sequence, which results in about 650,000 faces if the number of iterations of subdivision is 3.

If the number of iterations of subdivision is 8, the number of faces is 67,108,864, and the number of vertices is about 33,554,434. Just for vertex representation, 33,554,434×12=402,653,208 B is required per frame.

In order to represent the connectivity information, representation of each vertex index requires 26 bits, which is about 3 bytes. That is, 33,554,434×3=100,663,302 B is required. For mesh representation, 503,316,510 B (about 503 MB) is required per frame.

Considering a case where a plurality of pieces of past frame data are referred to in the decoding process and the like, even in the absence of texture, it may be necessary to limit the number of iterations of subdivision to only some patches.

Furthermore, in consideration of texture, it is necessary to map the vertices in the xyz coordinates to the uv coordinates. In a case where each of u and v is a 32-bit floating-point number, 33,554,434×8=268,435,472 B is required. A total of about 750 MB of memory is required per frame.

In a case where the memory is about 1 GB, which is a minimum unit of recent PC memory and that causes no problem even in an edge terminal, there is almost no memory that represents texture, and it is also difficult to perform a complex decoding process such as holding a past frame in a buffer.

### <7 Times>

If the number of iterations of subdivision is set to 7, which is the maximum number of iterations in a case where the number of iterations of subdivision is represented by 3 bits, the number of vertices is about 32,770. The xyz coordinates of the vertices are often represented by 32-bit floating-point numbers. That is, 12 bytes are required for one vertex. Just for vertex representation, 393,240 B (about 394 kB) is required per frame.

In addition, in the mesh representation, connectivity information that connects the vertices is also required, and in order to represent the connectivity information, it is necessary to output a vertex index at least once at each vertex.

In a case where the number of vertices is 32,770, representation of each vertex index requires 16 bits, which is about 2 bytes. One frame requires 32,770×2=65,540B (about 66 kB) to represent the connectivity information.

Therefore, at least 393,240+65,540=458,780 B (about 458 kB) is required per frame for mesh representation not including texture or the like.

The degree of freedom increases, including the memory related to holding the loaded data, the decoding process, and the texture, and the number of vertices before subdivision.

Here, as in the case where the number of iterations of subdivision is 8, it is assumed that the number of vertices of the base mesh before subdivision is 514 instead of 4.

It is about ¼ as compared with that in the case where the number of iterations of subdivision is 8, and it is about 190 MB even if the texture coordinates per frame are included.

Even with 1 GB of memory, it is possible to represent a complex decoding process that holds past frames and color texture information.

### <3 Times>

If the number of iterations of subdivision is set to 3, which is the maximum number of iterations in a case where the number of iterations of subdivision is represented by 2 bits, this is used as a default value of current reference software, and is a baseline because it can be decoded even in a case where complex texture is included.

Since it is the baseline, it is easy to design including the memory.

On the other hand, unevenness may be subjectively conspicuous depending on the use case, and it is also desirable to increase the number of iterations of subdivision to four or more depending on the use case.

To summarize the above, the number of iterations of subdivision (16 times) that requires 5 bits for representation is not possible in almost terminals from the viewpoint of memory, and 4 bits or less (15 times or less) is desirable.

However, in the case of 4 bits, there are constraints in which high-specification memory is required (15 times), and it is difficult to achieve complex shape representation, complex decoding processing, and complex texture together (8 times), and thus, iterations of subdivision of 3 bits or less (7 times or less) are more desirable.

In addition, the upper limit of the number of iterations of subdivision may be changed according to the desired level. For example, in a case where three levels are assumed, the number of iterations of subdivision may be set to a range in which it can be represented by 2 bits for a low level, which represents general quality, the number of iterations of subdivision may be set to a range in which it can be represented by 3 bits for a medium level, which represents high quality, and the number of iterations of subdivision may be set to a range in which it can be represented by 4 bits for a high level, which represents ultra-high quality.

According to the present embodiment, design can be facilitated by defining a reasonable constraint on the number of iterations of subdivision.

The mesh encoding device 100 and the mesh decoding device 200 described above may be implemented as programs that cause a computer to execute each function (each step).

Note that, according to the present embodiment, for example, comprehensive improvement in service quality can be realized in moving image communication, and thus, it is possible to contribute to goal 9 “Establish a resilient infrastructure, promote sustainable industrialization, and expand innovation” of the sustainable development goals (SDGs) led by the United Nations.

What is claimed is:

1. A mesh decoding device comprising:
an atlas data decoding unit configured to decode a syntax defining a maximum value of the number of iterations of subdivision, wherein
the syntax decoded by the atlas data decoding unit has a value of 7 or less.

2. The mesh decoding device according to claim 1, wherein
when high quality is set, the syntax decoded by the atlas data decoding unit has a value of 7 or less, and
when ultra-high quality is set, the syntax decoded by the atlas data decoding unit has a value of 15 or less.

3. A mesh decoding method comprising:
a step of decoding a syntax defining a maximum value of the number of iterations of subdivision, wherein
the syntax decoded in the step has a value of 7 or less.

4. A non-transitory computer-readable medium having stored thereon a program that is executable by a computer to cause the computer to function as a mesh decoding device, wherein
the mesh decoding device includes an atlas data decoding unit configured to decode a syntax defining a maximum value of the number of iterations of subdivision, and
the syntax decoded by the atlas data decoding unit has a value of 7 or less.
